(19) United States
(12) Patent Application Publication
(10) Pub. No.: US 2026/0336125 A1
(43) Pub. Date: Oct. 29, 2026

(54) Control Method for Controlling Transportation of Object, Transportation Device for Transporting Object, and Operation System Including Transportation Device

(71) Applicant: SHIMADZU CORPORATION, Kyoto-shi, Kyoto (JP)

(72) Inventors: Kazuma TAKAHARA, Kyoto-shi, Kyoto (JP); Shinji IMAI, Kyoto-shi, Kyoto (JP)

(73) Assignee: SHIMADZU CORPORATION, Kyoto-shi, Kyoto (JP)

(21) Appl. No.: 19/110,767

(22) PCT Filed: Aug. 22, 2023
(86) PCT No.: PCT/JP2023/030106

§ 371 Date: Mar. 11, 2025

(30) Foreign Application Priority Data
Sep. 12, 2022 (JP) 2022-144480

(51) Int. Cl. B25J 9/16; G06T 7/73

(52) U.S. Cl. CPC B25J 9/1697; G06T 7/74; G06T 2207/30204

(57) ABSTRACT

A control method is a method for controlling, using an image captured by an imaging unit (234), transportation of an object to a target position by a first migration body (232). The control method includes the steps of: performing approaching control to cause the imaging unit (234) to relatively approach a feature portion indicating a reference position different from the target position; causing the imaging unit (234) having been caused to relatively approach the feature portion by the approaching control to acquire a first image in which the feature portion is imaged; and causing the first migration body (232) to transport the object to the target position based on the first image.

### TECHNICAL FIELD

The present disclosure relates to a control method for controlling transportation of an object, a transportation device for transporting the object, and an operation system including the transportation device.

### BACKGROUND ART

In recent years, an effort has been made to use a robot to automate an operation of transporting an object such as a sample to a target position of an operation device.

In a situation in which such automation is attempted, a teaching operation must be performed in ordinary cases whenever a relative position between the robot and the operation device is changed due to system relocation or reassembly, maintenance during operation, or the like. The teaching operation is an operation of setting, by human, a timing at which the transportation robot should be moved as well as a manner in which the transportation robot should be moved. Since an action to be taken by the robot is changed depending on a relative position between the robot and the operation device, the teaching operation is required whenever the position of the operation device is changed. The teaching operation requires time and effort and may take several hours. Therefore, there has been known a technique of correcting an action of a robot in accordance with a target position recognized at the time of transportation in order to save time and effort for the teaching operation.

Non-patent literature entitled “Benchmark for Bimanual Robotic Manipulation of Semi-Deformable Objects” discloses that when assembling a watch using a robot, a feature portion (for example, a marker or the like) provided around the watch is imaged by a camera in order to recognize the position of the dial face of the watch.

### CITATION LIST

### Non Patent Literature

NPL 1: Konstantinos Chatzilygeroudis, et al., “Benchmark for Bimanual Robotic Manipulation of Semi-Deformable Objects)”, [online], IEEE ROBOTICS AND AUTOMATION LETTERS, VOL. 5, NO. 2, April 2020, [Searched on Jul. 12, 2022], the Internet, <URL:https://ieeexplore.ieee.org/abstract/document/8989777>

### SUMMARY OF INVENTION

### Technical Problem

In order to recognize a target position in a transportation operation by a robot, it is conceivable to apply the position recognition technique disclosed in the non-patent literature described above. When the position recognition technique disclosed in the non-patent literature is applied, the target position can be recognized by using the camera to image the feature portion provided at a position different from the target position in the transportation operation performed by the robot. When transporting an object with the target position being recognized in this way, there has been required a technique of more securely transporting the object to the target position.

The present disclosure has been made in view of such a circumstance, and has one object to provide a technique by which an object can be securely transported to a target position.

### Solution to Problem

A control method according to an aspect of the present disclosure is a control method for controlling, using an image captured by an imaging unit, transportation of an object to a target position by a first migration body. The control method includes the steps of: performing approaching control to cause the imaging unit to relatively approach a feature portion indicating a reference position different from the target position; causing the imaging unit having been caused to relatively approach the feature portion by the approaching control to acquire a first image in which the feature portion is imaged; and causing the first migration body to transport the object to the target position based on the first image.

A transportation device according to an aspect of the present disclosure includes: an imaging unit; a first migration body that transports an object to a target position; and a control unit that performs approaching control to cause the imaging unit to relatively approach a feature portion indicating a reference position different from the target position. The imaging unit having been caused to relatively approach the feature portion by the approaching control acquires a first image in which the feature portion is imaged. The first migration body transports the object to the target position based on the first image.

An operation system according to an aspect of the present disclosure includes: the above-described transportation device; and an operation device for an operation that uses the object transported by the transportation device.

### Advantageous Effects of Invention

According to the present disclosure, since the feature portion can be imaged by the imaging unit from the vicinity of the feature portion, a posture of the feature portion can be more precisely specified. The target position is specified by a relative positional relation with the reference position indicated by the feature portion. Therefore, when the posture of the feature portion is precisely specified, the target position is more precisely specified, with the result that the object is securely transported to the target position.

### BRIEF DESCRIPTION OF DRAWINGS

FIG. 1 is a diagram for illustrating an overview of an operation system in an embodiment.

FIG. 2 is a diagram showing an exemplary hardware configuration of the operation system in the embodiment.

FIG. 3 is a diagram for illustrating an overview of processes of a transportation device in the embodiment.

FIG. 4 is a flowchart showing a procedure of processes regarding control on a transportation robot among processes of a management device in the embodiment.

FIG. 5 is a diagram for illustrating a second mark in the embodiment.

FIG. 6 is a flowchart showing a procedure of a registration process in the embodiment.

FIG. 7 is a flowchart showing a procedure of an action plan creation process in the embodiment.

FIG. 8 is a flowchart showing a procedure of a transportation process in the embodiment.

FIG. 9 is a diagram showing a transportation robot in a modification 1.

### DESCRIPTION OF EMBODIMENTS

Hereinafter, embodiments and modifications of the present disclosure will be described in detail with reference to figures. It should be noted that the same or corresponding portions in the figures are denoted by the same reference characters and will not be described repeatedly. The embodiments and modifications described below may be selectively combined as appropriate.

### A. Overview of Operation System

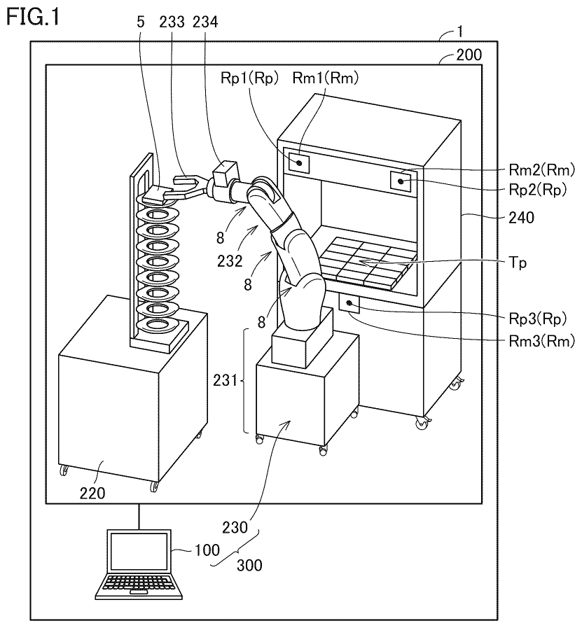

FIG. 1 is a diagram for illustrating an overview of an operation system in an embodiment. An operation system 1 in the embodiment includes a control-target device group 200 and a management device 100. Control-target device group 200 includes a transportation robot 230, an operation device 220, and an operation device 240.

Transportation robot 230 transports a well plate 5 from operation device 220 to a target position Tp in operation device 240. A sample to be used by operation device 220 and operation device 240 is accommodated in well plate 5. Well plate 5 in which the sample is accommodated is one example of “object” in the present disclosure. Each of operation device 220 and operation device 240 is one example of a device for an operation that uses the sample transported by transportation robot 230. Operation device 220 is a rack that holds well plate 5. Operation device 240 is a culture device for culturing bacteria included in the sample accommodated in well plate 5.

In the present embodiment, a system for experiment of culturing bacteria is employed as one example of operation system 1, the experiment is employed as one example of an operation on an object, and a device for experiment is employed as the operation device. It should be noted that the operation on an object is not limited to the experiment. Any type of operation, such as processing of metal, may be employed as the operation on an object. Therefore, any type of device that performs an operation on an object may be employed as the operation device, in addition to the device for experiment.

Management device 100 controls actions of transportation robot 230, operation device 220, and operation device 240. A transportation device 300 is a device including management device 100 and transportation robot 230.

Transportation robot 230 is a six-axis vertical articulated robot having one arm. Transportation robot 230 includes a main body portion 231, an arm 232, a gripper 233, and an imaging unit 234. Main body portion 231 holds arm 232. Arm 232 transports well plate 5 from operation device 220 to target position Tp in operation device 240. Arm 232 is one example of “first migration body” in the present disclosure. Gripper 233 is provided at the tip of arm 232 and grips well plate 5. Arm 232 includes one or more movable portions 8. By moving one or more movable portions 8, arm 232 can be moved upward/downward, leftward/rightward, and forward/backward. Thus, well plate 5 is transported from operation device 220 to target position Tp in operation device 240 by arm 232.

In the example of FIG. 1, control-target device group 200 includes the plurality of operation devices, and transportation robot 230 transports the object (well plate) from one operation device to another operation device of the plurality of operation devices. It should be noted that control-target device group 200 may be constituted of a single operation device, and transportation robot 230 may transport the object from one position to another position in the single operation device.

Imaging unit 234 is provided on arm 232 and acquires an image of an imaging target. The actions of arm 232, gripper 233, and imaging unit 234 are controlled by management device 100.

A first mark Rm1, a first mark Rm2, and a first mark Rm3 are attached to a physical object around transportation robot 230. First mark Rm1 indicates a reference position Rp1, first mark Rm2 indicates a reference position Rp2, and first mark Rm3 indicates a reference position Rp3.

In the description below, when attention is paid to a common property (of indicating the reference positions) among first mark Rm1, first mark Rm2, and first mark Rm3 and first mark Rm1, first mark Rm2, and first mark Rm3 are not required to be distinguished from one another, first mark Rm1, first mark Rm2, and first mark Rm3 are referred to as “first mark Rm”. First mark Rm is one example of “feature portion” in the present disclosure. First mark Rm is provided at a position different from target position Tp. First mark Rm may be a pattern by which a posture of first mark Rm can be specified, such as an AR (Augmented Reality) marker, a QR code (registered trademark), or the like, for example. In the present embodiment, the “posture” includes a position and an orientation. First mark Rm1, first mark Rm2, and first mark Rm3 are distinguishable from one another. For example, when first mark Rm1, first mark Rm2, and first mark Rm3 are implemented as QR codes, first mark Rm1, first mark Rm2, and first mark Rm3 are implemented as QR codes having different pieces of information.

In the description below, when attention is paid to a common property (of being the reference positions) among reference position Rp1, reference position Rp2, and reference position Rp3 and reference position Rp1, reference position Rp2, and reference position Rp3 are not required to be distinguished from one another, reference position Rp1, reference position Rp2, and reference position Rp3 are referred to as “reference position Rp”. Reference position Rp is located at a position different from target position Tp. In the present embodiment, target position Tp is recognized based on reference position Rp. By a below-described registration process, position information indicating a relative positional relation between target position Tp and reference position Rp is stored into management device 100.

Management device 100 performs approaching control to cause imaging unit 234 to relatively approach first mark Rm, and causes imaging unit 234 to image first mark Rm from the vicinity of first mark Rm. In the description below, the image acquired in this way is referred to as “first image”. The first image includes pixels indicating first mark Rm. Management device 100 corrects, based on the first image, an action plan of arm 232 created in advance by a teaching operation, and controls the action of transportation robot 230 based on the corrected action plan. Thus, in the present embodiment, the object can be securely transported to the target position.

### B. Hardware Configuration of Operation System

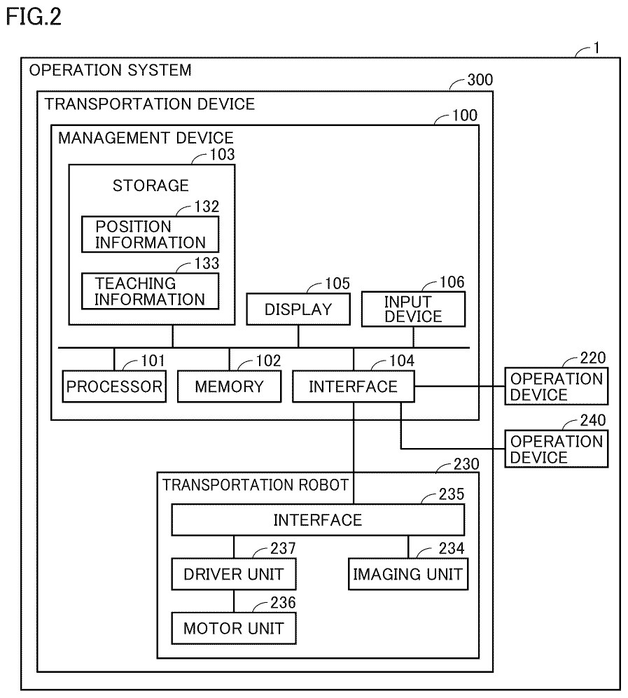

FIG. 2 is a diagram showing an exemplary hardware configuration of the operation system in the embodiment. Operation system 1 includes transportation device 300, operation device 220, and operation device 240. Transportation device 300 includes transportation robot 230 and management device 100.

Management device 100 is constituted of, for example, a general-purpose computer. In the example of FIG. 2, management device 100 includes a processor 101, a memory 102, a storage 103, an interface 104, a display 105, and an input device 106.

Processor 101 executes various programs so as to allow management device 100 to perform various processes. Processor 101 is constituted of a hardware element such as a CPU (Central Processing Unit) or an MPU (Micro-Processing Unit). Memory 102 functions as a main storage device and is constituted of, for example, a volatile storage device such as a DRAM (Dynamic Random Access Memory) or an SRAM (Static Random Access Memory).

Storage 103 stores a program to be executed by processor 101 and various data necessary for execution of the program, and is constituted of, for example, a nonvolatile storage device such as an SSD (solid state drive) or a flash memory.

It should be noted that the program may be provided as being incorporated into a part of any program, rather than a single program. In this case, a process according to the present embodiment is implemented in cooperation with any program. Even such a program not including some modules is not deviated from the gist of management device 100 according to the present embodiment. Further, part or whole of the functions provided by the program may be implemented by dedicated hardware.

Storage 103 stores position information 132 and teaching information 133. Position information 132 is stored into storage 103 by the below-described registration process, and teaching information 133 is stored into storage 103 by a below-described action plan creation process.

Interface 104 relays communication between management device 100 and an external device (for example, transportation robot 230, operation device 220, operation device 240 or the like).

Display 105 displays a result of an arithmetic process of processor 101, and input device 106 (for example, a mouse, a keyboard, a touch sensor, or the like) receives a manipulation of inputting data to processor 101.

Transportation robot 230 includes imaging unit 234, an interface 235, a motor unit 236, and a driver unit 237. Interface 235 relays communication between transportation robot 230 and management device 100. Motor unit 236 includes motors respectively associated with one or more movable portions 8. Driver unit 237 includes drivers that respectively drive the one or more motors included in motor unit 236.

### C. Overview of Processes of Transportation Device

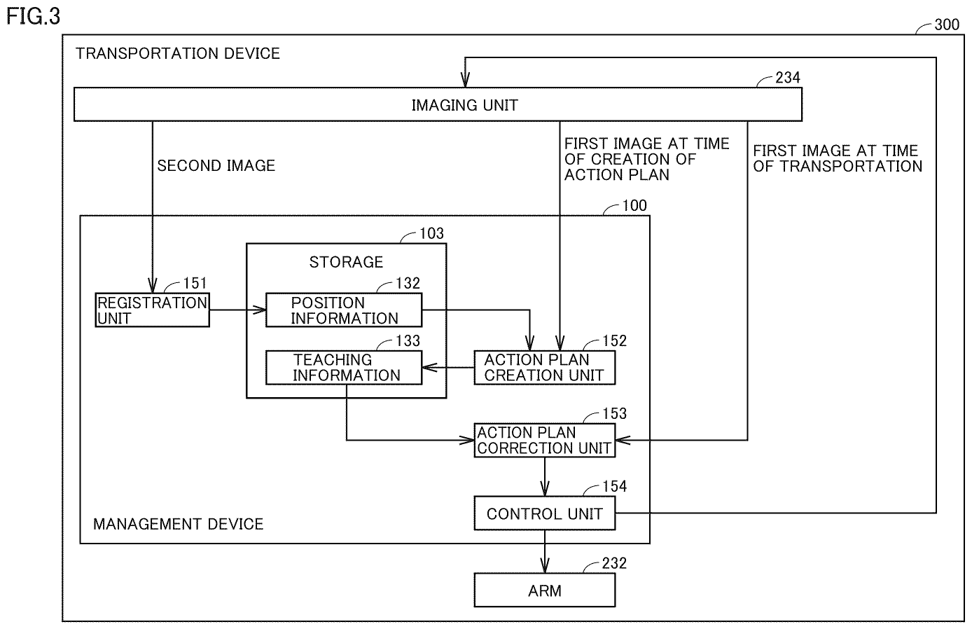

FIG. 3 is a diagram for illustrating an overview of processes of the transportation device in the embodiment. Transportation device 300 in the embodiment includes imaging unit 234, management device 100, and arm 232. Management device 100 includes a registration unit 151, storage 103, an action plan creation unit 152, an action plan correction unit 153, and a control unit 154. Registration unit 151, action plan creation unit 152, action plan correction unit 153, and control unit 154 are implemented by processor 101 executing the above-described program.

Imaging unit 234 acquires an image of an imaging target in accordance with an instruction from control unit 154. In the below-described registration process, imaging unit 234 acquires a second image. Imaging unit 234 acquires the first image in each of the below-described action plan creation process and a below-described transportation process. The second image includes pixels indicating the second mark and pixels indicating first mark Rm. Although the second mark will be described later, the second mark is attached to target position Tp by a user in order to indicate target position Tp.

When the second image is acquired from imaging unit 234, registration unit 151 first specifies a relative positional relation between target position Tp and reference position Rp based on the second image. Next, registration unit 151 stores, into storage 103, position information 132 indicating the relative positional relation between target position Tp and reference position Rp. The storing of position information 132 into storage 103 is one example of “registering the position information” in the present disclosure.

When the first image is acquired from imaging unit 234 in the below-described action plan creation process, action plan creation unit 152 first specifies the posture (position and orientation) of first mark Rm. In the description below, the posture of first mark Rm specified by action plan creation unit 152 is referred to as “first posture”.

Next, action plan creation unit 152 creates, in accordance with a setting manipulation (so-called teaching operation) by the user, the action plan of arm 232 for transportation of well plate 5 to target position Tp by transportation robot 230 in the device arrangement made at the time of the teaching operation. As one example, action plan creation unit 152 causes display 105 to display a simulation screen for planning an action of arm 232. On the simulation screen, the device arrangement made at the time of the teaching operation and target position Tp are displayed. Target position Tp displayed on the simulation screen is a position specified by action plan creation unit 152 based on the first posture and position information 132. The user plans the action of arm 232 on the simulation screen.

The action plan of arm 232 includes: a direction in which arm 232 is to be moved; and an amount by which arm 232 is to be moved. More specifically, the action plan of arm 232 includes information defining the action of arm 232 (for example, distance and/or velocity of movement in each of three-axis translational directions, or angle and/or angular velocity of rotation in each of the three-axis rotational directions). It should be noted that the action plan of arm 232 may include information defining an action that is to be performed by an element (for example, gripper 233, a motor for rotating a wheel attached to main body portion 231 of transportation robot 230, or the like) other than arm 232 and that contributes to the action of arm 232 for transporting the object.

The device arrangement means an arrangement of the plurality of devices included in control-target device group 200. In the example of FIG. 1, the device arrangement means an arrangement of operation device 220, transportation robot 230, and operation device 240.

Finally, action plan creation unit 152 stores, into storage 103, teaching information 133 in which the first posture and the action plan of arm 232 are associated with each other. It should be noted that action plan creation unit 152 may create, based on position information 132, the action plan of arm 232 for transportation of well plate 5 to target position Tp by transportation robot 230 in the device arrangement made at the time of the teaching operation.

When the first image is acquired from imaging unit 234 in the below-described transportation process, action plan correction unit 153 first specifies the posture (position and orientation) of first mark Rm. In the description below, the posture of first mark Rm specified by action plan correction unit 153 is referred to as “second posture”. Next, action plan correction unit 153 corrects the action plan included in teaching information 133, based on the first posture and the second posture.

Control unit 154 controls the action of imaging unit 234. In a certain aspect, control unit 154 instructs imaging unit 234 to start and end imaging. In another aspect, control unit 154 instructs imaging unit 234 to perform imaging.

Moreover, control unit 154 controls the action of arm 232. More specifically, control unit 154 outputs a motor driving instruction to a driver corresponding to a target movable portion 8. Thus, target movable portion 8 is moved, thereby moving arm 232 upward/downward, leftward/rightward, and/or forward/backward. In a certain aspect, control unit 154 controls the action of arm 232 so as to perform approaching control to cause imaging unit 234 to relatively approach first mark Rm. In another aspect, control unit 154 controls the action of arm 232 based on the corrected action plan.

### D. Procedure of Processes of Management Device

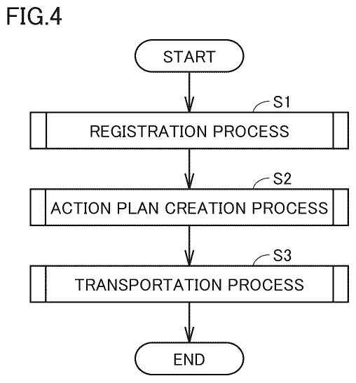

Referring to FIGS. 4 to 8, the following describes processes regarding control on transportation robot 230 among processes of management device 100 in the embodiment.

### (D1: Procedure of Process Regarding Control on Transportation Robot 230)

Referring to FIG. 4, the following describes a procedure of the processes regarding the control on transportation robot 230 among the processes of management device 100 in the embodiment. FIG. 4 is a flowchart showing the procedure of the processes regarding the control on the transportation robot among the processes of the management device in the embodiment. The series of processes shown in FIG. 4 are performed by processor 101 of management device 100.

In a step S1, processor 101 performs the registration process. The registration process is a process of registering position information 132 indicating the relative positional relation between target position Tp and reference position Rp.

In a step S2, processor 101 performs the action plan creation process. The action plan creation process is a process of creating, in accordance with a setting manipulation (so-called teaching operation) of the user, an action plan of arm 232 for transportation of well plate 5 to target position Tp by transportation robot 230 in the device arrangement made at the time of the teaching operation.

In a step S3, processor 101 performs the transportation process. The transportation process is a process of correcting, based on the first image, the action plan of arm 232 created in the action plan creation process and controlling the action of transportation robot 230 based on the corrected action plan. After step S3, the series of processes shown in FIG. 4 are ended.

### (D2: Registration Process)

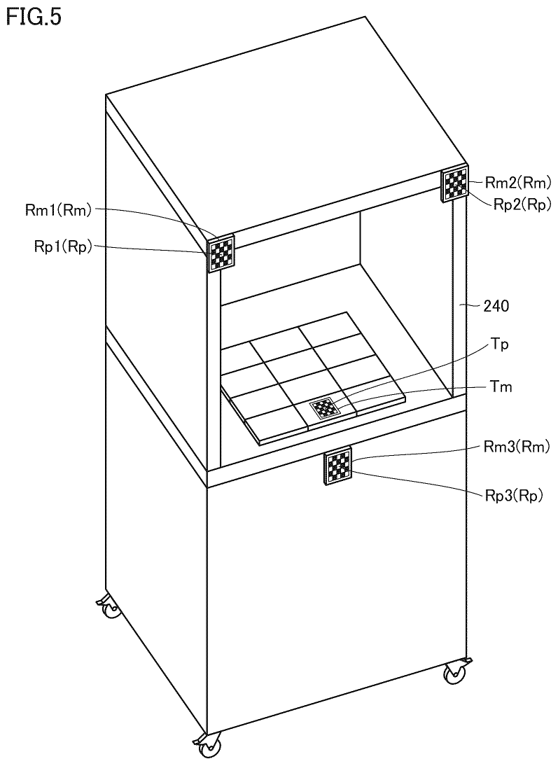

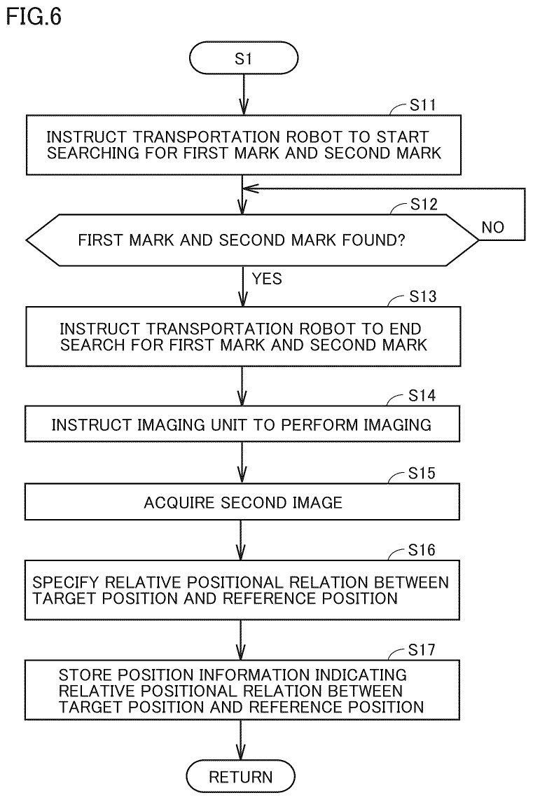

The process in step S1, i.e., the registration process will be described with reference to FIGS. 5 and 6.

The second mark attached to target position Tp will be described with reference to FIG. 5. FIG. 5 is a diagram for illustrating the second mark in the embodiment.

FIG. 5 shows operation device 240. As illustrated in FIG. 1, first mark Rm for indicating reference position Rp is attached to reference position Rp. A second mark Tm for indicating target position Tp is attached to target position Tp by the user before the start of the registration process. After the registration process is completed, second mark Tm is detached from target position Tp by the user.

Second mark Tm may be a pattern by which a posture (position and orientation) of second mark Tm can be specified, such as an AR marker, a QR code, or the like. The shape of second mark Tm is preferably the same as the shape of the object (for example, well plate 5 or the like) to be transported by transportation robot 230. More specifically, the shape of the front surface of second mark Tm and the shape of the bottom surface of the object to be transported by transportation robot 230 are preferably the same. When the shape of the front surface of second mark Tm and the shape of the bottom surface of the object to be transported by transportation robot 230 are the same, management device 100 can readily recognize the position (target position Tp) to which the object is to be transported in the registration process, with the result that more precise position information can be calculated.

FIG. 6 is a flowchart showing a procedure of the registration process in the embodiment. In a step S11, processor 101 instructs transportation robot 230 to start searching for first mark Rm and second mark Tm. More specifically, processor 101 instructs imaging unit 234 to start imaging, and instructs a driver corresponding to each of the one or more movable portions 8 so as to start driving a corresponding motor. Thus, the imaging by imaging unit 234 is started, and arm 232 is moved upward/downward, leftward/rightward, and forward/backward. Imaging unit 234 transmits the acquired image to processor 101.

In a step S12, processor 101 determines whether or not first mark Rm and second mark Tm have been found. When both pixels indicating first mark Rm and pixels indicating second mark Tm are included in the image transmitted from imaging unit 234, processor 101 determines that first mark Rm and second mark Tm have been found. When first mark Rm and second mark Tm have been found (YES in step S12), processor 101 proceeds the process to a step S13.

In step S13, processor 101 instructs transportation robot 230 to end the search for first mark Rm and second mark Tm. More specifically, processor 101 instructs imaging unit 234 to end the imaging, and instructs the driver corresponding to each of one or more movable portions 8 to stop driving the corresponding motor. Thus, arm 232 is stopped in a posture (position and orientation) taken at the timing at which first mark Rm and second mark Tm have been found.

In a step S14, processor 101 instructs imaging unit 234 to perform imaging. Thus, a second image including the pixels indicating first mark Rm and the pixels indicating second mark Tm is acquired by imaging unit 234. Imaging unit 234 transmits the second image to processor 101.

In a step S15, processor 101 acquires the second image from imaging unit 234.

In a step S16, processor 101 specifies a relative positional relation between target position Tp and reference position Rp based on the second image. More specifically, processor 101 specifies a relative positional relation between reference position Rp1 and target position Tp, a relative positional relation between reference position Rp2 and target position Tp, and a relative positional relation between reference position Rp3 and target position Tp based on the second image.

In a step S17, processor 101 stores, into storage 103, position information 132 indicating the relative positional relation between target position Tp and reference position Rp. After step S17, the process is returned to step S2.

It should be noted that in the example shown in FIG. 6, the relative positional relation between target position Tp and reference position Rp is specified based on the image including both the pixels indicating first mark Rm and the pixels indicating second mark Tm, i.e., the image in which first mark Rm and second mark Tm are imaged. However, an image in which first mark Rm is imaged and an image in which second mark Tm is imaged may be acquired, and the relative positional relation between target position Tp and reference position Rp may be specified based on these images. As one example, processor 101 may specify the relative positional relation between target position Tp and reference position Rp by estimating reference position Rp from the image in which first mark Rm is imaged and estimating target position Tp from the image in which second mark Tm is imaged.

Since the second image including the pixels indicating first mark Rm and the pixels indicating second mark Tm has been acquired by imaging unit 234 at the time at which step S13 is ended, the process of step S14 may be omitted. However, since first mark Rm and second mark Tm can be imaged with arm 232 being stopped by performing step S14 as in the example shown in FIG. 6, blur in the image can be suppressed.

### (D3: Action Plan Creation Process)

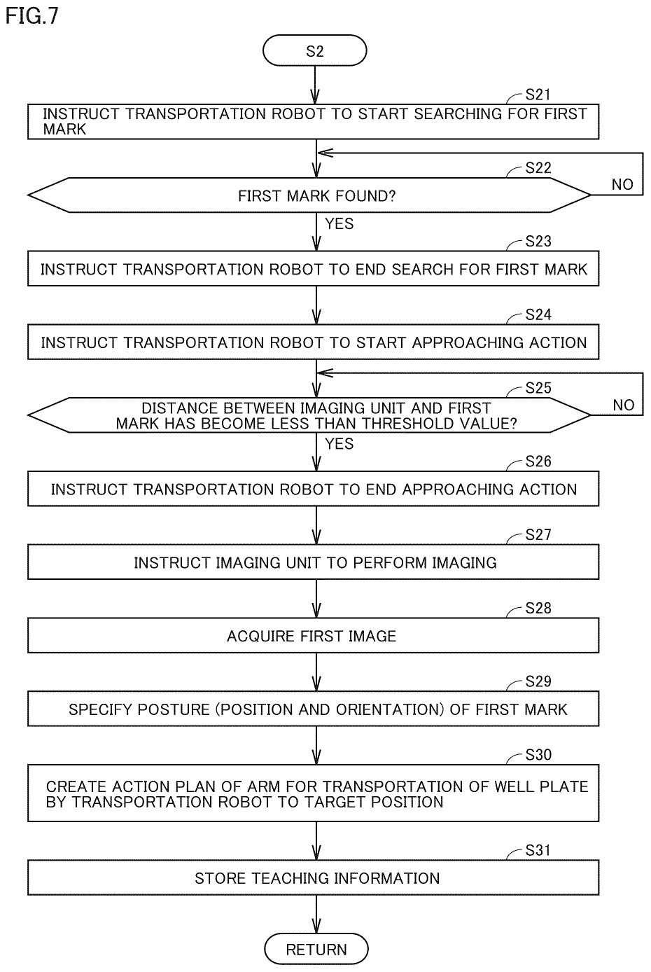

The process in step S2, i.e., the action plan creation process will be described with reference to FIG. 7. FIG. 7 is a flowchart showing a procedure of the action plan creation process in the embodiment.

In a step S21, processor 101 instructs transportation robot 230 to start searching for first mark Rm. More specifically, processor 101 instructs imaging unit 234 to start imaging, and instructs a driver corresponding to each of one or more movable portions 8 to start driving a corresponding motor. Thus, the imaging by imaging unit 234 is started, and arm 232 is moved upward/downward, leftward/rightward, and forward/backward. Imaging unit 234 transmits the acquired image to processor 101.

In a step S22, processor 101 determines whether or not first mark Rm has been found. When pixels indicating first mark Rm are included in the image transmitted from imaging unit 234, processor 101 determines that first mark Rm has been found. When first mark Rm has been found (YES in step S22), processor 101 proceeds the process to a step S23.

In step S23, processor 101 instructs transportation robot 230 to end the search for first mark Rm. More specifically, processor 101 instructs imaging unit 234 to end the imaging, and instructs the driver corresponding to each of one or more movable portions 8 to stop driving the corresponding motor. Thus, arm 232 is stopped in a posture (position and orientation) taken at the timing at which first mark Rm has been found.

In a step S24, processor 101 instructs transportation robot 230 to start an approaching action. More specifically, processor 101 instructs imaging unit 234 to start imaging, and instructs a driver, which corresponds to the movable portion for moving arm 232 forward/backward, to start driving a corresponding motor so as to move arm 232 forward. Thus, the approaching action is started by transportation robot 230. The approaching action is such that arm 232 is moved forward while imaging unit 234 performs imaging. Thus, imaging unit 234 approaches first mark Rm. Imaging unit 234 transmits the acquired image to processor 101.

In a step S25, processor 101 determines whether or not a distance between imaging unit 234 and first mark Rm has become less than a threshold value. Processor 101 determines whether or not the distance between imaging unit 234 and first mark Rm has become less than the threshold value, based on the size of a region occupied by the pixels indicating first mark Rm in the image transmitted from imaging unit 234. When the distance between imaging unit 234 and first mark Rm has become less than the threshold value (YES in step S25), processor 101 proceeds the process to a step S26.

In step S26, processor 101 instructs transportation robot 230 to end the approaching action. More specifically, processor 101 instructs imaging unit 234 to end the imaging, and instructs the driver, which corresponds to the movable portion for moving arm 232 forward/backward, to end driving the corresponding motor so as to stop moving arm 232 forward. Thus, arm 232 is stopped at a position at which the distance between imaging unit 234 and first mark Rm is less than the threshold value.

In a step S27, processor 101 instructs imaging unit 234 to perform imaging. Thus, the first image including the pixels indicating first mark Rm is acquired by imaging unit 234 located at the position at which the distance from first mark Rm is less than the threshold value. That is, by the process of step S27, imaging unit 234 images first mark Rm from the position close to first mark Rm. Imaging unit 234 transmits the first image to processor 101.

In a step S28, processor 101 acquires the first image from imaging unit 234.

In a step S29, processor 101 specifies the posture of first mark Rm. The posture of first mark Rm specified in step S29 of the action plan creation process (step S2) is the “first posture” described above.

In a step S30, processor 101 creates, in accordance with the setting manipulation (so-called teaching operation) of the user, the action plan of arm 232 for transportation of well plate 5 to target position Tp by transportation robot 230 in the device arrangement made at the time of the teaching operation.

In a step S31, processor 101 stores, into storage 103, teaching information 133 in which the first posture and the action plan of arm 232 created in step S30 are associated with each other. After step S31, the process is returned to step S3.

### (D4: Transportation Process)

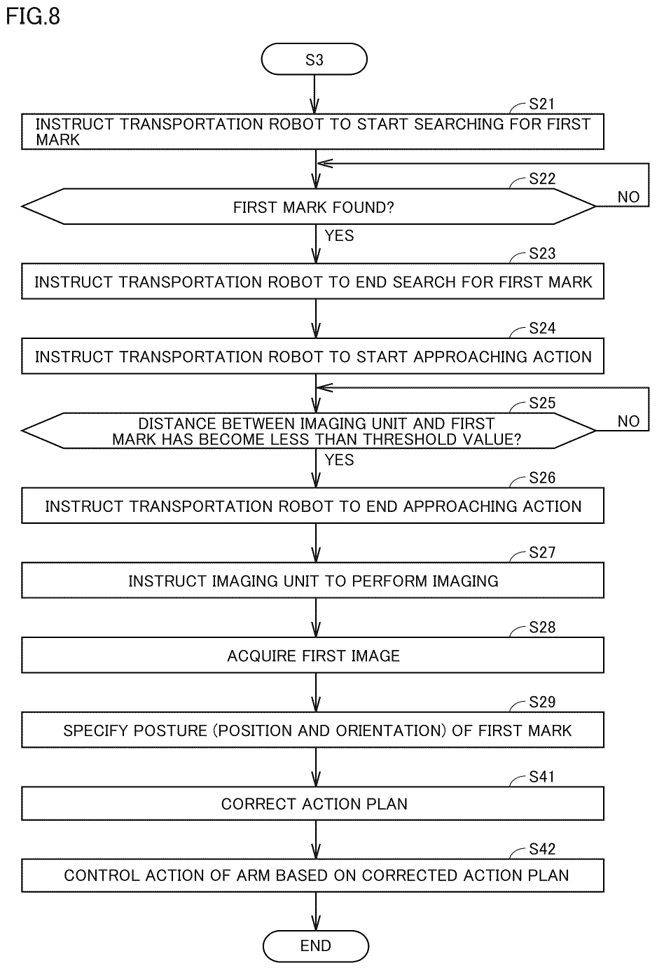

Referring to FIG. 8, the process in step S3, i.e., the transportation process will be described. FIG. 8 is a flowchart showing a procedure of the transportation process in the embodiment. Among the processes shown in FIG. 8, the same processes as those shown in FIG. 7 are denoted by the same step numbers, and will not be described repeatedly.

After performing steps S21 to S29, processor 101 proceeds the process to a step S41. The posture of first mark Rm specified in step S29 of the transportation process (step S3) is the “second posture” described above.

In step S41, processor 101 corrects the action plan included in teaching information 133 based on the first posture specified in step S29 of the action plan creation process (step S2) and the second posture specified in step S29 of the transportation process (step S3). As one example, when processor 101 compares the first posture and the second posture and can accordingly specify that first mark Rm in the transportation process is deviated by one centimeter to the right from its position in the action plan creation process, processor 101 corrects the action plan to deviate the trajectory of arm 232 to the right by one centimeter. In this way, an action plan corresponding to the device arrangement made at the time of the transportation process is created.

In a step S42, processor 101 controls the action of arm 232 based on the corrected action plan. More specifically, based on the corrected action plan, processor 101 outputs a motor driving instruction to a driver corresponding to a target movable portion 8 among the drivers included in driver unit 237. Thus, target movable portion 8 is moved to move arm 232 upward/downward, leftward/rightward, and/or forward/backward, thereby securely transporting well plate 5 to target position Tp. After step S42, the transportation process is ended, thereby ending the series of processes shown in FIG. 4.

Thus, in the present embodiment, management device 100 performs the approaching control to cause imaging unit 234 to relatively approach first mark Rm, and causes imaging unit 234 to image first mark Rm from the vicinity of first mark Rm. Since imaging unit 234 images first mark Rm from the vicinity of first mark Rm, precision in recognition of first mark Rm is improved, thereby more precisely specifying the posture of first mark Rm. The fact that the posture of first mark Rm can be specified more precisely because target position Tp is specified by the relative positional relation with reference position Rp indicated by first mark Rm means that target position Tp can be specified more precisely. Therefore, the object can be securely transported to target position Tp.

Further, since the action plan is corrected even when the device arrangement is changed between the teaching operation and the transportation of the object, the user does not need to perform the teaching operation again. Therefore, the time and effort of the user can be reduced.

Moreover, even when the device arrangement is slightly changed between the teaching operation and the transportation of the object, the posture of first mark Rm can be more precisely specified because imaging unit 234 images first mark Rm from the vicinity of first mark Rm. Therefore, an amount of deviation between the posture of first mark Rm at the time of the teaching operation and the posture of first mark Rm at the time of the transportation of the object can be more precisely specified. Therefore, an amount of correction of the action of arm 232 can be calculated more precisely, with the result that the object can be securely transported to target position Tp.

Further, first mark Rm is provided at a position different from target position Tp. If first mark Rm is provided at target position Tp, first mark Rm is hidden by the object after the object is transported. Therefore, when taking out the object using transportation robot 230, first mark Rm cannot be recognized, with the result that the object cannot be correctly taken out. However, since first mark Rm is provided at the position different from target position Tp in the present embodiment, the object can be correctly taken out from target position Tp even when taking out the object using transportation robot 230.

Moreover, if first mark Rm is provided at target position Tp, an operation of a device (for example, operation device 240 in the example of FIG. 1) at a position to which the object is transported may be hindered. For example, when operation device 240 performs measurement by transmitting light to pass through well plate 5, the measurement cannot be performed correctly if a mark that prevents the passage of the light is provided at the installation position of well plate 5, i.e., at target position Tp. However, in the present embodiment, since first mark Rm is provided at the position different from target position Tp, the operation of the device at the position to which the object is transported is not hindered.

### Modification 1

In the above embodiment, the transportation robot having one arm is employed as the transportation robot, but a transportation robot having two arms may be employed instead of the transportation robot having one arm.

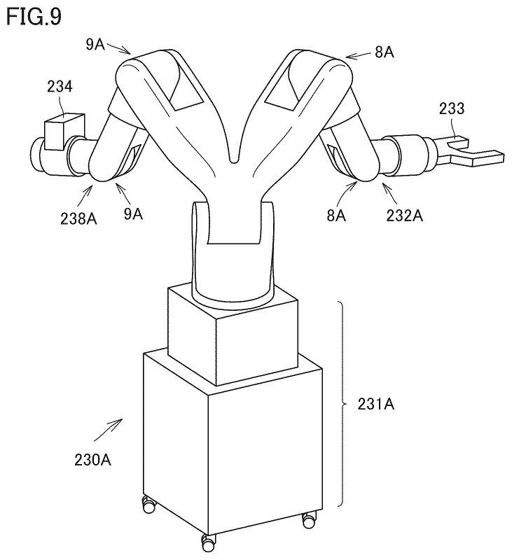

FIG. 9 is a diagram showing a transportation robot in a modification 1. A transportation robot 230A in modification 1 is a six-axis vertical articulated robot having two arms. Transportation robot 230A includes a main body portion 231A, an arm 232A, an arm 238A, a gripper 233, and an imaging unit 234.

Main body portion 231A holds arm 232A and arm 238A. Arm 232A and arm 238A share and play the three roles played by arm 232 in the embodiment. The first role is to search for an imaging target (for example, first mark Rm, second mark Tm, or the like). The second role is to cause imaging unit 234 to approach first mark Rm.

The third role is to transport well plate 5. Arm 232A plays the third role, and arm 238A plays the first role and the second role.

Arm 232A transports well plate 5 from operation device 220 to target position Tp in operation device 240. Arm 232A is one example of “first migration body” in the present disclosure. Gripper 233 is provided at the tip of arm 232A and grips well plate 5. Arm 232A includes one or more movable portions 8A. By moving one or more movable portions 8A, arm 232A can be moved upward/downward, leftward/rightward, and forward/backward. Therefore, well plate 5 is transported from operation device 220 to target position Tp in operation device 240 by arm 232A.

Arm 238A is one example of “second migration body” in the present disclosure. Imaging unit 234 is provided on arm 238A and acquires an image of an imaging target. Arm 238A includes one or more movable portions 9A. By moving one or more movable portions 9A, arm 238A can be moved upward/downward, leftward/rightward, and forward/backward. Therefore, the imaging target can be searched for and imaging unit 234 can be caused to approach first mark Rm.

The actions of arm 232A, arm 238A, gripper 233, and imaging unit 234 are controlled by management device 100. When transportation robot 230A is employed as the transportation robot, motor unit 236 shown in FIG. 2 includes motors respectively associated with one or more movable portions 8A, and motors respectively associated with one or more movable portions 9A.

Further, when transportation robot 230A is employed as the transportation robot, management device 100 performs, onto arm 238A, control associated with the first role and the second role, and performs, onto arm 232A, control associated with the third role, among the controls on arm 232 as described above. When transportation robot 230A is employed as the transportation robot, it is assumed that the action plan of arm 232 as described above is replaced with the action plan of arm 232A. Thus, the object can be securely transported to target position Tp.

It should be noted that main body portion 231A may be configured to be moved relative to target position Tp. As an exemplary configuration in which main body portion 231A is moved relative to target position Tp, main body portion 231A is provided with wheels. By driving the wheels, main body portion 231A is moved leftward/rightward and forward/backward. As a result, transportation robot 230A is moved leftward/rightward and forward/backward. When main body portion 231A is configured to be moved relative to target position Tp, the action of main body portion 231A is controlled by management device 100.

When main body portion 231A is configured to be moved relative to target position Tp, main body portion 231A may be moved and arm 232A and arm 238A may not be moved until the distance between imaging unit 234 and first mark Rm has become less than the threshold value in the above transportation process (step S3). Thus, arm 232A and arm 238A can be simultaneously moved by the same amount. Therefore, well plate 5 can be transported to target position Tp by moving arm 232A from the position at which arm 232A is located at the time at which the distance between imaging unit 234 and first mark Rm has become less than the threshold value, with the result that an amount of movement of arm 232A can be suppressed. Therefore, transportation precision in transporting the object to target position Tp is improved.

### Modification 2

In the above embodiment, three first marks Rm attached to operation device 240 are each exemplified as the “feature portion”, but the feature portion is not limited thereto. The “feature portion” may include one or more first marks Rm. When a plurality of first marks Rm are provided, target position Tp can be specified more precisely than when only one first mark Rm is provided. Therefore, the transportation precision in transporting the object to target position Tp is improved.

Moreover, instead of one or more first marks Rm, the feature portion may be a portion of an operation device (for example, operation device 240 or the like) included in operation system 1. The portion of the operation device included in operation system 1 is, for example, a logo engraved in the operation device, a corner of the operation device, or the like. Also when the portion of the operation device included in operation system 1 is used as the feature portion, a plurality of locations in the operation device may be used as the feature portion, or only one location in the operation device may be used as the feature portion. When a plurality of locations in the operation device are used as the feature portion, target position Tp can be more precisely specified than when only one location in the operation device is used as the feature portion. Therefore, the transportation precision in transporting the object to target position Tp is improved.

Moreover, the feature portion may include: one or more first marks Rm; and one or more locations in an operation device (for example, operation device 240 or the like) included in operation system 1.

### Modification 3

In the above embodiment, it has been illustratively described that imaging unit 234 is caused to approach first mark Rm as the approaching control, but it is not limited thereto. When operation device 240 to which first mark Rm is attached is configured to be movable by the control of management device 100, management device 100 may perform, as the approaching control, control to cause operation device 240 to approach imaging unit 234. Moreover, when operation device 240 to which first mark Rm is attached is configured to be movable by the control of management device 100, management device 100 may perform, as the approaching control, control to cause both operation device 240 and imaging unit 234 to approach each other.

### Modification 4

Transportation robot 230 in the above embodiment may be configured to travel on a rail provided on a floor, or may be configured to travel in any pattern by itself on the floor.

### Modification 5

In the above embodiment, the process of registering the position information indicating the relative positional relation between target position Tp and reference position Rp is performed using transportation robot 230, but the user may measure the position information and register the position information in management device 100. When the user measures the position information and registers the position information in management device 100, the shape of second mark Tm and the shape of the object (for example, well plate 5 or the like) to be transported by transportation robot 230 are preferably the same. More specifically, the shape of the front surface of second mark Tm and the shape of the bottom surface of the object to be transported by transportation robot 230 are preferably the same. When the shape of the front surface of second mark Tm and the shape of the bottom surface of the object to be transported by transportation robot 230 are the same, the user can readily know the position (target position Tp) to which the object is to be transported, and therefore efficiency of the measurement operation of the position information is improved.

### Modification 6

In the above embodiment, it has been described that the object is transported to operation device 240 by using transportation robot 230, but the above embodiment may also be applied to a case where the object is taken out from operation device 240 by using transportation robot 230.

### Implementations

It will be understood by one having ordinary skill in the art that the exemplary embodiments described above are specific examples of the following implementations.

(Item 1) A control method according to one implementation is a control method for controlling, using an image captured by an imaging unit, transportation of an object to a target position by a first migration body, the control method comprising the steps of:
performing approaching control to cause the imaging unit to relatively approach a feature portion indicating a reference position different from the target position;
causing the imaging unit having been caused to relatively approach the feature portion by the approaching control to acquire a first image in which the feature portion is imaged; and
causing the first migration body to transport the object to the target position based on the first image.

In the control method according to item 1, the imaging unit can be caused to image the feature portion from the vicinity of the feature portion, thereby more precisely specifying a posture of the feature portion. The target position is specified by a relative positional relation with the reference position indicated by the feature portion. Therefore, when the posture of the feature portion is precisely specified, the target position is more precisely specified, with the result that the object is securely transported to the target position.

(Item 2) In the control method according to item 1, the feature portion includes a plurality of elements distinguishable from each other.

In the control method according to item 2, since the plurality of elements are provided, the target position can be specified more precisely than when only one element is provided. Therefore, transportation precision in transporting the object to the target position is improved.

(Item 3) In the control method according to item 1 or 2, the feature portion includes a first mark provided to indicate the reference position.

In the control method according to item 3, since the first mark is provided at the reference position, the reference position can be recognized at a glance.

(Item 4) In the control method according to item 1 or 2, the feature portion includes a location in an operation device for an operation that uses the object.

In the control method according to item 4, since it is not necessary to provide the first mark serving as the feature portion, time and effort of the user can be saved.

(Item 5) In the control method according to any one of items 1 to 4, the imaging unit is provided on the first migration body.

In the control method according to item 5, the number of migration bodies provided in the transportation robot can be suppressed.

(Item 6) In the control method according to any one of items 1 to 4, the imaging unit is provided on a second migration body different from the first migration body.

In the control method according to item 6, since the first migration body for transporting the object to the target position is not provided with the imaging unit, the first migration body becomes compact. Thus, the first migration body can be moved in a narrower space.

(Item 7) In the control method according to item 6, a main body portion that holds the first migration body and the second migration body is configured to be moved relative to the target position.

In the control method according to item 7, the first migration body and the second migration body can be simultaneously moved by the same amount.

(Item 8) In the control method according to any one of items 1 to 7, in a registration process of registering position information indicating a relative positional relation between the target position and the reference position, a second mark for indicating the target position is provided at the target position,
the control method further comprising the steps of:
causing the imaging unit to acquire a second image in which the second mark and the feature portion are imaged; and
specifying the position information based on the second image and registering the position information.

In the control method according to item 8, since the user does not need to measure and register the position information, the time and effort of the user can be saved.

(Item 9) A transportation device according to another implementation comprises:
an imaging unit;
a first migration body that transports an object to a target position; and
a control unit that performs approaching control to cause the imaging unit to relatively approach a feature portion indicating a reference position different from the target position, wherein
the imaging unit having been caused to relatively approach the feature portion by the approaching control acquires a first image in which the feature portion is imaged, and
the first migration body transports the object to the target position based on the first image.

In the transportation device according to item 9, since the imaging unit can image the feature portion from the vicinity of the feature portion, the posture of the feature portion can be more precisely specified. The target position is specified by the relative positional relation with the reference position indicated by the feature portion. Therefore, when the posture of the feature portion is precisely specified, the target position is more precisely specified, with the result that the object is securely transported to the target position.

(Item 10) In the transportation device according to item 9, the feature portion includes a plurality of elements distinguishable from each other.

In the transportation device according to item 10, since the plurality of elements are provided, the target position can be specified more precisely than when only one element is provided. Therefore, transportation precision in transporting the object to the target position is improved.

(Item 11) In the transportation device according to item 9 or 10, the feature portion includes a first mark provided to indicate the reference position.

In the transportation device according to item 11, since the first mark is provided at the reference position, the reference position can be recognized at a glance.

(Item 12) In the transportation device according to item 9 or 10, the feature portion includes a location in an operation device for an operation that uses the object.

In the transportation device according to item 12, since it is not necessary to provide the first mark serving as the feature portion, time and effort of the user can be saved.

(Item 13) In the transportation device according to any one of items 9 to 12, the imaging unit is provided on the first migration body.

In the transportation device according to item 13, the number of migration bodies provided in the transportation robot can be suppressed.

(Item 14) The transportation device according to any one of items 9 to 12 further comprises a second migration body different from the first migration body, wherein
the imaging unit is provided on the second migration body.

In the transportation device according to item 14, since the first migration body for transporting the object to the target position is not provided with the imaging unit, the first migration body becomes compact. Thus, the first migration body can be moved in a narrower space.

(Item 15) The transportation device according to item 14 further comprises a main body portion that holds the first migration body and the second migration body, wherein
the main body portion is configured to be moved relative to the target position.

In the transportation device according to item 15, the first migration body and the second migration body can be simultaneously moved by the same amount.

(Item 16) In the transportation device according to any one of items 9 to 15, in a registration process of registering position information indicating a relative positional relation between the target position and the reference position, a second mark for indicating the target position is provided at the target position, and
the imaging unit acquires a second image in which the second mark and the feature portion are imaged,
the transportation device further comprising a registration unit that specifies the position information based on the second image and that registers the position information.

In the transportation device according to item 16, since the user does not need to measure and register the position information, the time and effort of the user can be saved.

(Item 17) An operation system according to another aspect is an operation system comprising: the transportation device according to any one of items 9 to 16; and an operation device for an operation that uses the object transported by the transportation device.

In the operation system according to item 17, since the imaging unit can image the feature portion from the vicinity of the feature portion, a posture of the feature portion can be more precisely specified. The target position is specified by a relative positional relation with the reference position indicated by the feature portion. Therefore, when the posture of the feature portion is precisely specified, the target position is more precisely specified, with the result that the object is securely transported to the target position.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

1 operation system; 5 well plate; 8, 8A, 9A movable portion; 100 management device; 101 processor; 102 memory; 103 storage; 104, 235 interface; 105 display; 106 input device; 132 position information; 133 teaching information; 151 registration unit; 152 action plan creation unit; 153 action plan correction unit; 154 control unit; 200 control-target device group; 220, 240 operation device; 230, 230A transportation robot; 231, 231A main body portion; 232, 232A, 238A arm; 233 gripper; 234 imaging unit; 236 motor unit; 237 driver unit; 300 transportation device; Rm, Rm1, Rm2, Rm3 first mark; Rp, Rp1, Rp2, Rp3 reference position; Tm second mark; Tp target position.

1. A control method for controlling, using an image captured by an imaging unit, transportation of an object to a target position by a first migration body, the control method comprising the steps of:
searching for a feature portion indicating a reference position different from the target position using the imaging unit;
performing approaching control to cause the imaging unit to relatively approach the feature portion when it is determined that the feature portion has been found;
causing the imaging unit having been caused to relatively approach the feature portion by the approaching control to acquire a first image in which the feature portion is imaged; and
causing the first migration body to transport the object to the target position based on the first image.

2. The control method according to claim 1, wherein the feature portion includes a plurality of elements distinguishable from each other.

3. The control method according to claim 1, wherein the feature portion includes a first mark provided to indicate the reference position.

4. The control method according to claim 1, wherein the feature portion includes a location in an operation device for an operation that uses the object.

5. The control method according to claim 1, wherein the imaging unit is provided on the first migration body.

6. The control method according to claim 1, wherein the imaging unit is provided on a second migration body different from the first migration body.

7. The control method according to claim 6, wherein a main body portion that holds the first migration body and the second migration body is configured to be moved relative to the target position.

8. The control method according to claim 1, wherein
in a registration process of registering position information indicating a relative positional relation between the target position and the reference position, a second mark for indicating the target position is provided at the target position,
the control method further comprising the steps of:
causing the imaging unit to acquire a second image in which the second mark and the feature portion are imaged; and
specifying the position information based on the second image and registering the position information.

9. A transportation device comprising:
an imaging unit;
a first migration body that transports an object to a target position; and
a control unit, wherein
the control unit
searches for a feature portion indicating a reference position different from the target position using the imaging unit, and
performs approaching control to cause the imaging unit to relatively approach the feature portion when the control unit determines that the feature portion has been found,
the imaging unit having been caused to relatively approach the feature portion by the approaching control acquires a first image in which the feature portion is imaged, and
the first migration body transports the object to the target position based on the first image.

10. The transportation device according to claim 9, wherein the feature portion includes a plurality of elements distinguishable from each other.

11. The transportation device according to claim 9, wherein the feature portion includes a first mark provided to indicate the reference position.

12. The transportation device according to claim 9, wherein the feature portion includes a location in an operation device for an operation that uses the object.

13. The transportation device according to claim 9, wherein the imaging unit is provided on the first migration body.

14. The transportation device according to claim 9, further comprising a second migration body different from the first migration body, wherein the imaging unit is provided on the second migration body.

15. The transportation device according to claim 14, further comprising a main body portion that holds the first migration body and the second migration body, wherein the main body portion is configured to be moved relative to the target position.

16. The transportation device according to claim 9, wherein
in a registration process of registering position information indicating a relative positional relation between the target position and the reference position, a second mark for indicating the target position is provided at the target position, and
the imaging unit acquires a second image in which the second mark and the feature portion are imaged,
the transportation device further comprising a registration unit that specifies the position information based on the second image and that registers the position information.

17. An operation system comprising: the transportation device according to claim 9; and an operation device for an operation that uses the object transported by the transportation device.
